(19) United States
(12) Patent Application Publication
(10) Pub. No.: US 2005/0289588 A1
(43) Pub. Date: Dec. 29, 2005

(54) System and method for targeting video advertisements

(76) Inventor: D. Scott Kinnear, Sammamish, WA (US)

Correspondence Address: DEAN A. CRAINE, P.S., STE 140, 400 - 112TE AVE. NE, BELLEVUE, WA, 98004, US

(21) Appl. No.: 10/877,719

(22) Filed: Jun. 25, 2004

(51) Int. Cl. H04N 7/10; G06F 3/00; G06F 13/00

(52) U.S. Cl. 725/35; 725/32; 725/42

(57) ABSTRACT

An improved system and method for advertising to video program viewers that sends a signal from a signal provider that contains a video program file, a video advertisement file, a video program data file, and a video advertisement data file to a viewer's addressable video recording device (DVR). When the signal is received by the DVR, the video and program and data files are separated and stored locally in separate databases. The video program file may be delivered directly to the viewer' television or monitor for immediate viewing. The video program data information file contains the target demographic profile information and the commercial break information for the video program. The video advertisement file and the video advertisement data file are stored in a video advertisement library database and video advertisement information, database, respectively. Loaded into the memory of the DVR is an advertisement play list generator software program that generates a list of advertisements stored on the DVR recorder to be played back during the video program.

### BACKGROUND OF THE INVENTION

1. Field of the Invention

This invention relates to systems and methods for advertising to television viewers, and more particularly, to improved systems and methods of more efficiently targeting advertisements to television viewers.

2. Description of the Related Art

Television networks and stations transmit television programs to millions of viewers twenty-four hours a day, seven days a week. For commercial television networks, a main source of revenue is derived from advertising for others between and during their television programs.

It is commonly known to target advertisements to viewers of a particular television program. Typically, network executives determine the demographics of viewers that watch a particular program, and then offer advertising “slots” before and during the program to advertisers interested in presenting advertisements to these viewers. Unfortunately, many viewers who watch a particular program are outside the targeted demographic profile identified by the network. For these “non-targeted” viewers, the advertisements presented are less effective.

It is postulated that one reason why viewers ‘channel surf’ during commercial breaks, is their disinterest in the products or services presented in the advertisements. If specific advertisements could be targeted to interested viewers, ‘channel surfing’ would be reduced therefore making it more likely that the advertisements would be seen. Unfortunately, under the currently available network television advertisement models, targeting specific advertisements to individuals is not possible.

Another problem with the currently network television advertisement model is that it does not meet the advertising needs of local, neighborhood businesses. Because the majority of customers of many local neighborhood businesses are often located within a 5 to 10 mile radius of the business, the delivery of advertisements to viewers outside a 5 to 10 mile radius of the business is inefficient.

Video tape recorders and digital video recorders are commonly used by viewers to record selected television programs for later viewing, hereinafter called ‘time shifted’ viewing. From a viewer's perspective, the main benefit of recording a program on a VCR or DVR for later viewing is that it allows the viewer to watch programs at a more convenient time. Another benefit is that it allows viewers to delete or skip advertisements when watching the program. Obviously, deleting or skipping over advertisements is more likely if the advertisement is not targeted to the viewer. The increase in ‘time shifted’ viewing is a major concern to television networks and advertisers who are now searching alternative systems and methods of advertising.

### SUMMARY OF THE INVENTION

Disclosed herein is a system and method for improved targeting of video advertisements to viewers of cable or satellite television programs that downloads a plurality of video advertisements from the network or cable/satellite operator onto a viewer's personal video recording device. The video advertisements downloaded into the video recording device are then selected by a proprietary software program also loaded into the video recording device and played back during commercial breaks.

The system and method uses an embedded signal from the network or cable/satellite operator to an addressable video recording device, such as a digital video recorder. The embedded signal includes one to four of the following files: a video program file, a video advertisement file, a video program data file, and a video advertisement data file. When the embedded signal is received by the video recording device, the four database files are separately stored in a video program library database, a video advertisement library database, a video program information database, and a video advertisement information database, respectively.

When connected to the service, the video program data file may be delivered directly to the viewer's television for immediate viewing or stored in the video recording device's video program library databank for later viewer. Each video program file as a video program data file associated therewith that contains demographic information for target viewers of the video program file. The video program file also contains information regarding the number of advertisement breaks or slots in the video program file, their relative time location in the video program file, and their duration.

The video advertisement files are downloaded from the service provider into the video advertisement library databank while viewing a video program file or at off times during the day. As stated above, associated with each video advertisement file is a video advertisement data file that contains formation regarding the general subject of the product or service sold in the video advertisement file, the demographic information target viewers of the video advertisement file, and the length of the video advertisement file. The associated video advertisement data files are stored in the video advertisement information databank.

Loaded into the working memory of the video recorder device is an advertisement video generator software program that determines which video program file is currently being viewed, examines the video program data file associated with the video program file to determine the number of commercial breaks in the video program file, their exact located in the video program file, and their duration in the program. The advertisement video generator software program then instructs a second program called an advertisement play list generator software program also loaded into the working memory of the video recorder device to select a set of video advertisement files from the video advertisement library database to be played during the commercial breaks in the video program file. When a particular video program file is selected by a viewer, the video generator software program and the advertisement play list generator software program operate automatically to quickly creates a set video advertisement files to be shown to the viewer taking into consideration the information in the video program data file, the video advertisements data file, and the viewer's demographic information provided by the service provider.

When the viewer watches a “live” program, the video advertisement files that accompany the video program file may be shown in place of video advertisements files already downloaded and stored in the video advertisement library information database. When the viewer ‘channel surfs’ during a commercial break, the video recorder device may quickly modify the play list of video advertisements already assembled with a new play list of video advertisement files that takes into consideration the new video program and its schedule of commercial breaks.

In the preferred embodiment, the video program files, the video advertisement files, the video program data files, and the video advertisement data files are delivered simultaneously to the video recording device. It should be understood, however, that the video program, the video advertisement files, the video program data files and the advertisement data files may be delivered independently at different times. By independently delivering these four files to the video recording device, each may be individually updated and changed by the network or cable/satellite service provider thereby enabling the network to more efficiently target the advertisements.

### DESCRIPTION OF THE DRAWINGS

FIG. 1 is a schematic diagram of the personal advertising targeting and playback method and system.

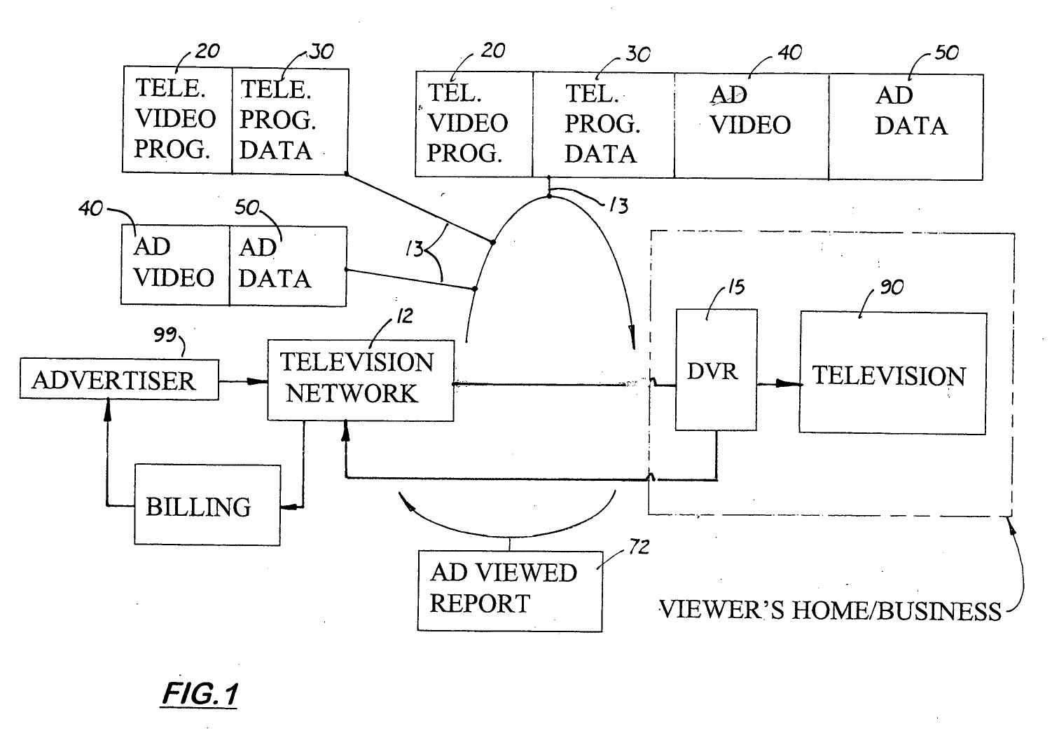

FIG. 2 is a schematic diagram of the embedded signal delivered to a DVR containing a hard drive and working memory.

FIG. 3 is a flow chart of the system.

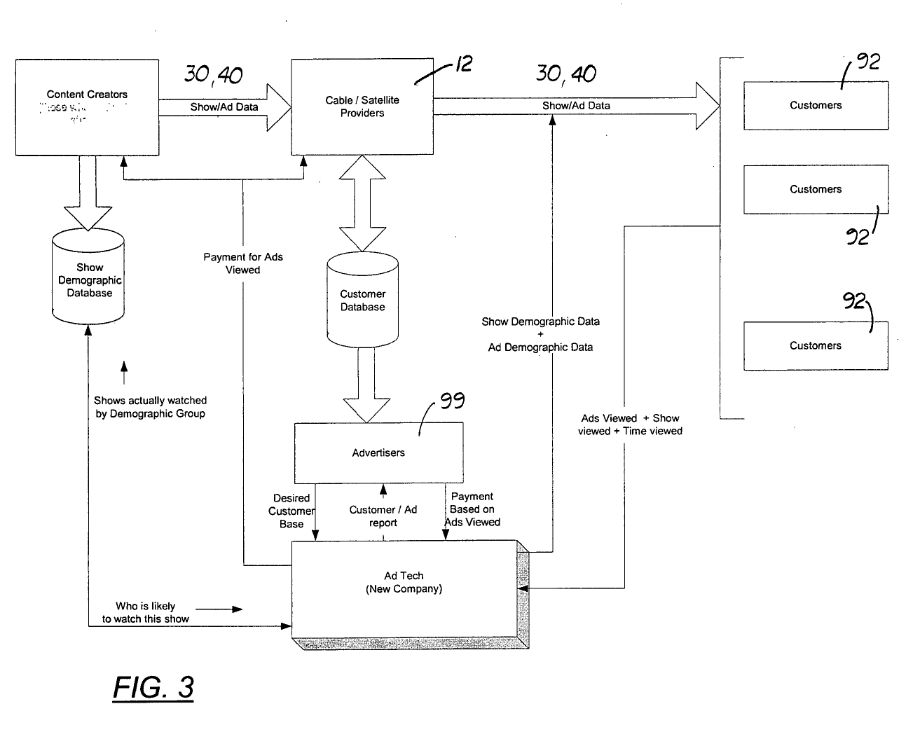

FIG. 4 is a flow chart showing how the video programs and video advertisements are processed.

### DESCRIPTION OF THE PREFERRED EMBODIMENT(S)

Referring to Figs, there is disclosed an improved system 10 and method for targeting video advertising by downloading a plurality of video advertisement files 30 from a network or cable/satellite service 12 onto a viewer's video recording device 15. The video advertisement files 30 are stored locally onto an internal long term memory device, such as a hard drive, or tape drive or onto an external device, such as an external hard drive or a network server. The advertisement files 30 are selected and processed by software programs 60, 65 loaded into device's working memory 17 for playing back to the viewer currently or later during the advertisement breaks or slots in the video program file 20.

The system 10 uses an embedded signal 13 produced by a network or service 12 that is delivered to an addressable video recording device 15 connected to the viewer's display 90. When the embedded signal 13 is delivered to the video recording device 15, it is divided via a splitter 16 into a video program file 20, a video advertisement file 30, a video program data file 40 and a video advertisement data file 50.

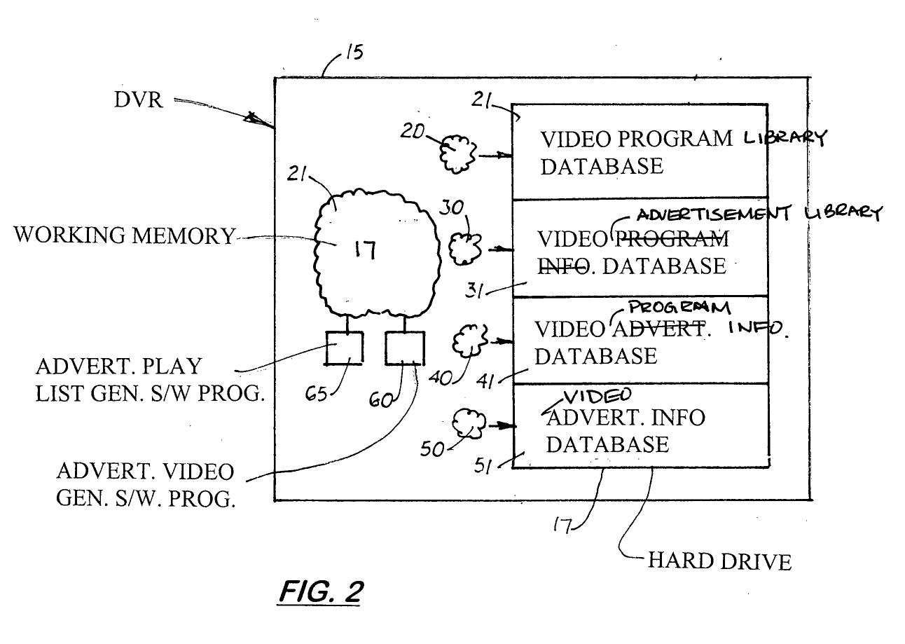

In the preferred embodiment, the video recording device 15 is a digital video recorder, hereinafter referred to as a DVR, with one or more hard drives 16 capable of storing several hours of analog and digital video program files 20, video advertisement files 30 and data files 40, 50. As shown in FIG. 2, created on the device's hard drive 16 is a video program library database 21, a video advertisement library database 31, a video program information database 41, and an advertisement information library database 51. Loaded into the working memory 17 of the DVR 15 is an advertisement play list generator program 60 and an advertisement video generator software program 65. The advertisement play list generator software program 60 processes the information from the video advertisement library database 31, the video advertisement information database 41 and the video advertisement information database 51 and delivers it to the vide advertisement generator software program 65. The advertisement generator software program 65 then selects a set of video advertisement files 30 for delivery to the television 90. A show video generator software program 45 assembles and delivers a selected video program file 20 from the video program library database 21 which is combined from the set of video advertisement files 30 produced by the video advertisement generator software program 65 to produce a fully integrated video program 35 to the viewer 92.

When an embedded signal 13 is delivered to the DVR 15, the video program file 30 it may be stored on the device's video program library database 21 for later viewing or shown immediately on the viewer's display 90. As stated above, associated with each video program file 20 is a video program data file 40 that identifies the demographic profile of the targeted viewer of the video program file 20 and the number and lengths of commercial breaks in the video program file 20. When the embedded signal 13 is received to the DVR 15, the video program data file 40 associated with the video program file 20 is automatically stored in the video program information database 41. If the video program file 20 is shown immediately, or saved on the video program library database 21 for showing later, the video program data file 40 is used by the advertisement generator software program 60 and the advertisement play list generator software program 65 loaded into the working memory 17 to select specific video advertisement files 30 in the video advertisement library database 31 to play during the commercial breaks in the video program file 20.

Using the system 10, video advertisement files 30 are stored in the video advertisement library database 31. The video advertisement files 30 may be downloaded to the DVR 15 in one of four ways: (1) dark recording wherein a recorder is turned off yet able to tune into a pre-selected channel and download video advertisement files 30 to download; (2) timed recording wherein the video digital recorder 15 is tuned on and programmed to initiate downloading at selected times; (3) alternative channel recording where video advertisements 30 are downloaded from a different channel; and (4) opportunity/tagged recording where the video advertisement 30 is recorded as it is watched and then played back at selected times.

The video program files 20 and video advertisement files 30 are downloaded in either compressed on uncompressed format. In the preferred embodiment, the first set of 1800 frames of each video advertisement file 30 is downloaded in a decoded format and stored in an uncompressed format on the DVR 15. This allows the frames of the video advertisement file 30 to be switched accurately without having to wait for compression decode logic to work.

When initially signing up to the system 10, the viewer 92 submits demographic information and information regarding the types of products and services that interest the viewer 92. The service 12 assigns a unique identification number to the viewer 92 or to the viewer's DVR 15. When the DVR 15 is connected to the service 12, the DVR 15 queries the service's server, and transmit's the viewer's or DVR's identification number. If the demographic information has not been previously submitted, the viewer's demographic information 93, which also may be stored on the DVR 15 may be transmitted to the server at this time.

When the viewer 92 watches a video program file 20, the demographic information in the video program data file 40 associated with the video program file 20 is matched with the desired demographic information associated with the video advertisement files 30 in the DVR's video advertisement library database 31. During use, the advertisement video generator software program 60 examines the information in the video program data file 40 to determine the number of commercial breaks in the video program file 20, their exact located in the video program file 20 and their lengths. The advertisement video generator software program 60 then instructs the advertisement play list generator software program 65 to select a set of video advertisement files 30 from the advertisement library database 31 for viewing with the video program file 20. The advertisement play list generator software program 65 selects which video advertisement files 30 to play and their order of play back. One function of the advertisement play list generator software program 65 is to monitor the frequency a particular video advertisement is played in predetermined length of time, (e.g. previous 24 hr or 7 day period). For example, if a video advertisement file 30 has been already been played a pre-determined number of times in a selected period, the advertisement play list generator software program 65 will remove the video advertisement file 30 from the list. Another function of the advertisement play list generator software program 65 is to prevent the same video advertising file 30 from being shown at the same time on different channels.

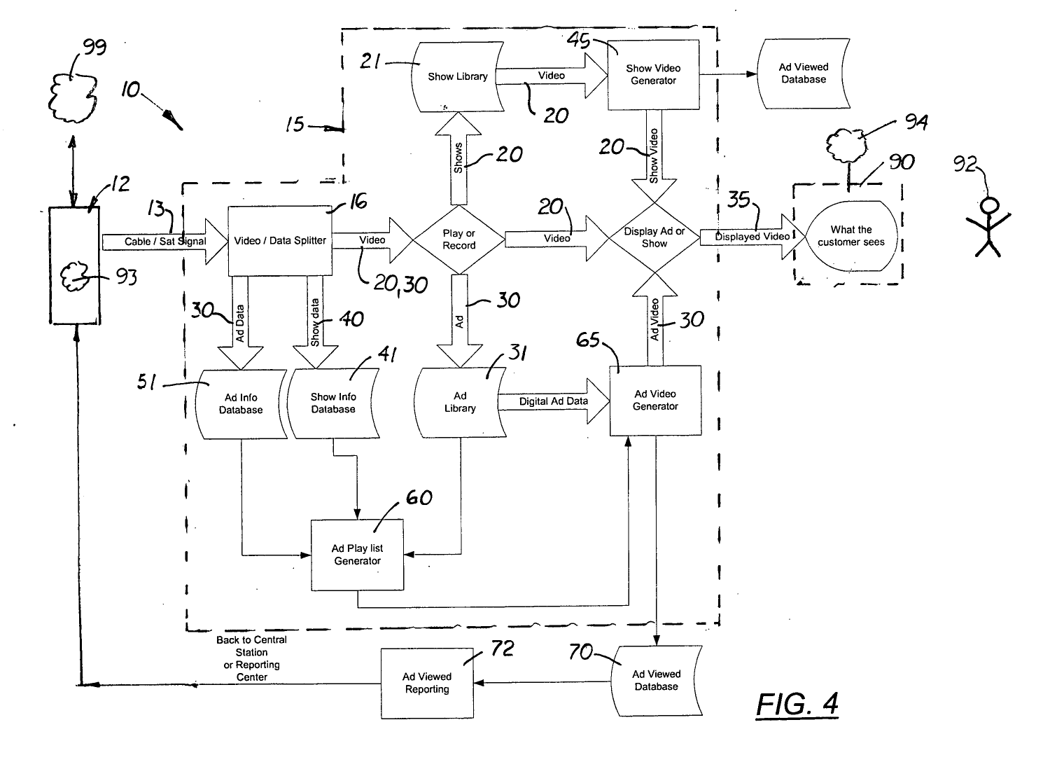

An important feature of the system 10 is that the viewer 92 can selectively modify the advertisement library database 31 to delete or block video advertisement files 30. In this instance, a menu 94 shown in FIG. 4 maybe provided on the viewer' display 90 that includes a deletion and a block buttons (not shown) to permanently delete or block video advertisement 30 files from the video advertisement library database 31.

As stated above, the video program data file 40 contains information regarding the video program file 20 delivered to the DVR 15. Such information includes the subject matter of the video program file 20, its viewer rating, its intended audience, the number commercial breaks during the program, the length of the commercial break, and their occurrence during the video program file 20. Such information is used by the advertisement video generator software program 65 to select different video advertisement files 30 in the video advertisement library databank 31 to play back to the viewer 92 when viewing a video program file 20.

The video advertisement files 30, are typically 15 seconds, 30, seconds or 60 seconds in length. In the preferred embodiment, the video advertisement files 30 are delivered with the video program file 20, the video program data file 40, and the video advertisement data file 50. It should be understood however, that the video advertisement file 20, the video advertisement file 30, video program file 40, and the video advertisement file 50 may be delivered separately and at different times.

As noted above, the advertisement video generator software program 60 and the advertisement play list generator software program 65 use the video advertisement library database 31 to present video advertisement files when a video program file is being watched. When a video advertisement file 30 is played back to the viewer, it is recorded in video advertisement viewed database 70 also created on the video recorder device 15. At the end of a billing cycle, the number of times a particular video advertisement file 30 is played on the device 15, is submitted in a report 72 delivered to the service's billing office, which then combines the information with other billing services to prepare a final bill to the advertisers.

Because the video program file 20 and the video advertisement files 30 are separate files, the viewer 92 is able to contact the service 12 and request that only specific types of video advertisements be delivered.

An important benefit of the system 10 is that the number of times a video advertisement file 30 is shown to the viewer 92 can be accurately determined. Also, the number of times a video advertisement file 30 is shown to a targeted viewer can be accurately determined.

Another benefit of the system 10 is that selected video advertisement files 30 can be deleted or blocked by the viewer 92. Such deleted or blocked video advertisements are not charged to the advertiser.

Another benefit of the system 10 is that the exact date and time a video advertisement 30 file is viewed may be determined. Also, the specific video program being viewed when the video advertisement files 30 is viewed can be easily determined thereby provide the network more accurate targeting information.

Another benefit of the system 10 is that it allows the service 12 to present advertisements to local viewers 92 for local products and service advertisers 99.

In summary, a method of targeting advertising is provided comprising the following steps:
a. selecting an embedded signal service provider;
b. selecting a video recording device having a memory storage means capable for storing video and data files delivered from said service provider;
c. connecting a display to said video recording device;
d. transmitting a video program file from said signal service provider to said video recording device;
e. transmitting a video program data file associated with said video program file to said video recording device, said video program data file being transmitted by said service provider, said video program data file indicate containing information regarding the targeted demographic profile of a viewer of said video program file and the timing of at least one commercial break in said video program file;
f. transmitting at least one video advertisement file to said video recording device;
g. transmitting an advertisement data file to said video recording device, said advertisement data file being associated with one said video advertisement file and containing demographic information for a targeted viewer; and,
h. selecting an advertising play list generator software program that reviews said video program data file and said advertisement data file to generate at least one advertisement to play to a viewer watching said video program file associated with said video program data file.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

1. A video network advertising system, comprising;
a. a video signal service provider capable of transmitting a plurality of program video programs to its subscribers, a video program file associated with each said video program, a plurality of video advertisements, and a video advertisement data file associated with each said video advertisement;
b. a video recording device connected to said video signal service provider, said video recording device including a working memory and a means for long term memory capable of recording from said video signal service provider a plurality of said program videos into a video program library and recording said video advertisements into a video advertisement library;
c. an advertising play list generator software program loaded into said working memory of said video recording device, said advertising play list generator software program used to select at least one video advertisement from said video advertisement library for playback during a video program selected by a subscriber of said service; and,
d. at least one video display connected to said video recording device, said video display used to present selected video programs and selected video advertisements from said video recording device.

2. The video network advertising system, as recited in claim 1, further including a video generator software program loading into said working memory, said video generator software program used to determine the location of advertisement breaks in said video program file currently being viewed, the duration of the advertisement breaks in said video program file, and the duration of advertisement breaks in said video program file.

3. The video network advertising system, as recited in claim 1, wherein said video program file includes the number of advertisement breaks in said video program file and the location of said breaks in said video program file.

4. The video network advertising system, as recited in claim 1, wherein said video advertisement data file includes targeted demographic information for associated with said video advertisement file.

5. The video network advertising system, as recited in claim 3, wherein said video advertisement data file includes demographic information associated with the targeted viewers of said video advertisement file.

6. The video network advertising system, as recited in claim 1, wherein said video program files are stored in a video program library database directly connected to said video recording device.

7. The video network advertising system, as recited in claim 6, wherein said video advertisement files are stored in a video advertisement library database directly connected to said video recording device.

8. The video network advertising system, as recited in claim 7, wherein said video program files are stored in a video program library database connected to said video recording device.

9. The video network advertising system, as recited in claim 8, wherein said advertisement data file are stored in a video advertisement information database connected to said video recording device.

10. The video network advertising system, as recited in claim 1, further including a video advertisement library database coupled to said video recording device, said video advertisement library database used to record a plurality of said video advertisement files from said service provider.

11. The video network advertising system, as recited in claim 10, wherein said video program information data files is stored in a video program information database connected to said video recording device.

12. The video network advertising system, as recited in claim 11, wherein said video advertisement data file is stored in an advertisement information database connected to said video recording device.

13. The video network advertising system, as recited in claim 1, wherein said video program data file is stored in a video program information database connected to said video recording device.

14. A video network advertising system, comprising;
a. a video signal service provider capable of transmitting a plurality of program video programs to a subscriber, a video program data file associated with each said video program, a plurality of video advertisements, and a video advertisement data file associated with each said video advertisement, said video program file includes advertisement playback information which includes information on the number of advertisement video slots in said video program, the time location of said advertisement video slots in said video program, said video advertisement data file includes targeted demographic information for associated with each said video advertisement file;
b. a video recording device connected to said video signal service provider, said video recording device including a working memory and a means for long term memory capable of recording from said video signal service provider a plurality of said program videos into a video program library and recording said video advertisements into a video advertisement library;
c. a video generator software program loading into said working memory, said video generator software program used to determine the location of advertisement breaks in said video program file currently being viewed, the duration of the advertisement breaks in said video program file, and the duration of advertisement breaks in said video program file
d. an advertising play list generator software program loaded into said working memory of said video recording device, said advertising play list generator software program used to select at least one video advertisement from said video advertisement library for playback during a video program selected by a subscriber of said service, said video advertisements being selected based on matching the targeted, demographic profile information of a viewer of the video program and the targeted, demographic profile information of the video advertisement; and,
e. at least one video display connected to said video recording device, said video display used to present selected video programs and selected video advertisements from said video recording device.

15. The video network advertising system, as recited in claim 14, wherein said video programs are stored in a video program data file coupled to said video recording device.

16. The video network advertising system, as recited in claim 14, wherein said video advertisements are stored in a video advertisement library data file directly connected to said video recording device.

17. The video network advertising system, as recited in claim 14, wherein said video program information data is stored in a video program information database connected to said video recording device.

18. An improved method for targeting video advertisements to a viewer of a video program, comprised on the following steps:
a. selecting a video signal service provider capable of transmitting video program and data information associated therewith to a viewer's video display;
b. selecting a video recording device connected to said video signal service provider, said video recording device having a memory storage means capable of storing video and data information delivered from said video signal service provider, said video recording device including an advertising play list generator used to select and playback at least one advertisement stored in memory on said video recording device that is played back to a viewer while watching a video program on a video display connected to said video recording device;
c. connecting a video display to said video recording device;
d. transmitting a video program from said video signal service provider to said video recording device;
e. transmitting a video program data file associated with said video program file to said video recording device, said video program data file being transmitted by said video signal service provider, said video program data file containing information regarding the targeted demographic profile of a viewer of said video program and advertisement timing information in said video program;
f. transmitting at least one advertisement video from said video signal service provider to said video recording device;
g. transmitting an advertisement data file associated with said advertisement video, said advertisement data file containing demographic information for a targeted viewer; and,
h. operating said advertising play list generator software program that reviews said video program data file and said advertisement data file to generate at least one advertisement to play to a viewer watching said video program associated with said video program data file.

19. The method as recited in claim 18, further including the step (i) collecting information on the number of advertisement videos shown to a viewer.

20. The method as recited in claim 18, further including the step (j) billing advertisers based on the number of advertisements video shown to said viewer.

21. The method as recited in claim 18, further including the step (k) collecting demographic information about a viewer and then using said viewer demographic information to select an advertisement video to be delivered to a viewer.
